(19) United States
(12) Patent Application Publication
(10) Pub. No.: US 2026/0323418 A1
(43) Pub. Date: Oct. 15, 2026

(54) CARRIER AGGREGATION IN SIDELINK COMMUNICATION

(71) Applicant: TOYOTA JIDOSHA KABUSHIKI KAISHA, Toyota-shi, Aichi-ken (JP)

(72) Inventors: Takayuki SHIMIZU, Mountain View, CA (US); Claude ARZELIER, Varna (BG); Kai-Erik SUNELL, Naantali (FI); Nuno KIILERICH PRATAS, Gistrup (DK); Berthold PANZNER, Holzkirchen (DE); Renato BARBOSA ABREU, Aalborg (DK); Thomas JACOBSEN, Noerresundby (DK); Daniel MEDINA, Munchen (DE); Torsten WILDSCHEK, Gloucester (GB)

(73) Assignee: TOYOTA JIDOSHA KABUSHIKI KAISHA, Toyota-shi, Aichi-ken (JP)

(21) Appl. No.: 19/117,351

(22) PCT Filed: Sep. 8, 2023
(86) PCT No.: PCT/JP2023/032928

§ 371 Date: Mar. 31, 2025

Related U.S. Application Data
(60) Provisional application No. 63/377,572, filed on Sep. 29, 2022.

(51) Int. Cl. H04W 36/00; H04L 5/00; H04W 72/25

(52) U.S. Cl. CPC H04W 36/00692; H04L 5/0055; H04W 72/25

(57) ABSTRACT

Disclosed are methods, apparatuses, and systems for sidelink carrier aggregation. The methods include: transmitting one or more packets on one or more carriers of a plurality of carriers that are to be used for a sidelink carrier aggregation; determining at least one of: reception of an acknowledgment (ACK) from each of one or more target receiver user equipment (UEs), or non-reception of a negative acknowledgement (NACK) on at least one of the one or more carriers of the plurality of carriers; and canceling one or more remaining transmissions or re-transmissions for the one or more packets scheduled on the one or more carriers of the plurality of carriers, in response to a determination of at least one of: reception of the ACK from at least one of the one or more target receiver UEs, or non-reception of the NACK on the at least one of the one or more carriers of the plurality of carriers.

### CROSS-REFERENCE TO RELATED PATENT APPLICATION

This application claims the benefit of U.S. Provisional Application No. 63/377,572, filed on Sep. 29, 2022, entitled “CARRIER AGGREGATION IN SIDELINK COMMUNICATION,” the entirety of which is incorporated by reference herein.

### FIELD

Apparatuses and methods consistent with the present disclosure relate generally to communications, more specifically, methods, systems, and devices for carrier aggregation in sidelink communications.

### BACKGROUND

Carrier aggregation may allow for increased throughput and/or improved reliability in sidelink communications. To improve reliability, a transmitter user equipment (UE) in a sidelink communication may transmit the same transport block on each of multiple aggregated carriers. The transmitter UE may need to transmit the transport block in a manner of unicast or groupcast, which usually involve an acknowledgement (ACK) signal or a negative acknowledgement (NACK) signal from a receiver UE. Thus, for a unicast or groupcast, the transmitter UE keeps performing retransmission of the transport block until it receives an ACK or confirms no NACK from all target receiver UE(s) on all the sidelink carriers on which the same transport block is transmitted, even if communication on at least one of the sidelink carriers is successful. This minimizes spectral efficiency in sidelink carrier aggregation. Improved systems and methods for sidelink carrier aggregation for unicast or groupcast are desired.

The resource selection procedure of 3rd Generation Partnership Project (3GPP) Release 16/17 5G New Radio (NR) vehicle-to-everything (V2X) PC5 mode 2 is specified in 3GPP Technical Specification (TS) 38.213, TS 38.214, and TS 38.321. For resource selection, a UE performs channel sensing in a sensing window and collects another UE's resource reservation information based on sidelink control information (SCI) decoding to identify candidate resources in a selection window T (T=[T₁, T₂]). First, the UE excludes some time slots from the selection window due to unmonitored resources in the sensing window that the UE cannot sense due to its own transmission (i.e., half-duplex constraint). Then, the UE further excludes resources reserved by other UEs from the selection window if the corresponding sidelink-reference signal received power (SL-RSRP) exceeds the (pre-)configured SL-RSRP exclusion threshold. After resource exclusion, the number of candidate resources shall be at least X% of the total number of resources in the selection window. Otherwise, UE increases SL-RSRP exclusion threshold by 3 dB until obtaining at least X% resources, where X is (pre-)configured from {20, 35, 50}%. Finally, the UE randomly selects resources among candidate resources in the selection window. The selected frequency resource can be used for multiple times with a fixed time interval for subsequent transmissions (i.e., semi-persistent scheduling (SPS)) or only once (i.e., one-shot transmission (OST)). Also, the UE can retransmit packets multiple times (i.e., hybrid automatic repeat request (HARQ) retransmissions) with or without feedback from receiver UEs to improve the reliability.

In order for a UE to perform sensing and obtain information to receive other UEs' packets, the UE decodes SCI first. In Release 16, there are 1 st-stage SCI (SCI format 1-A) and 2^{nd}-stage SCI (SCI format 2-A or 2-B) as defined in 3GPP TS 38.212. 1^{st}-stage SCI carries resource reservation information for future transmissions, as well as information about resource allocation and modulation and coding scheme (MCS) for physical sidelink shared channel (PSSCH), demodulation reference signal (DMRS) pattern, 2^{nd}-stage SCI format, etc. 2^{nd-}stage SCI carries control information for HARQ procedures, source/destination IDs, information for distance-based groupcast (UE's zone identification (ID) and communication range requirement), etc. Based on the resource reservation contained in 1st-stage SCI, each UE avoids using time/frequency resources reserved by other UEs when it performs resource (re-)selection.

In Release 17 5G NR-V2X PC5 mode 2, inter-UE coordination (IUC) is introduced, in which a first UE (UE-A) sends coordination information about resources to a second UE (UE-B), and the UE-B utilizes that information for its resource (re-)selection. The following two schemes of inter-UE coordination are supported:

IUC scheme 1: A UE-A can provide to a UE-B indications of resources that are preferred to be included in the UE-B's (re-)selected resources, or preferred to be excluded. When given resources to include, the UE-B may rely only on those resources, at least if it does not support sensing/resource exclusion, or may combine them with resources identified by its own sensing procedure, before making a final selection. The indication from the UE-A to the UE-B is sent in medium access control (MAC) control element (CE) and/or 2^{nd}-stage SCI.

IUC scheme 2: A UE-A can provide to a UE-B an indication that resources reserved for UE-B's transmission (which may or may not be to the UE-A) will be, or could be, subject to conflict with a transmission from another UE. Then, the UE-B re-selects new resources to replace them. The indication from the UE-A to the UE-B is sent in a physical sidelink feedback channel (PSFCH).

### SUMMARY

According to some embodiments of the present disclosure, there is provided a method for carrier aggregation in a sidelink communication. The method includes transmitting, by a first UE, one or more packets on one or more carriers of a plurality of carriers that are to be used for a sidelink carrier aggregation; determining, by the first UE, at least one of: reception of an ACK from each of one or more target receiver UEs, or non-reception of a NACK on at least one of the one or more carriers of the plurality of carriers; and canceling, by the first UE, one or more remaining transmissions or re-transmissions for the one or more packets scheduled on the one or more carriers of the plurality of carriers, in response to a determination of at least one of: reception of the ACK from at least one of the one or more target receiver UEs, or non-reception of the NACK on the at least one of the one or more carriers of the plurality of carriers.

According to some embodiments of the present disclosure, there is provided a first UE. The first UE includes a memory storing an instruction; and a processor configured to execute the instruction stored in the memory to: transmit one or more packets on one or more carriers of a plurality of carriers that are to be used for a sidelink carrier aggregation; determine at least one of: reception of an ACK from each of one or more target receiver UEs, or non-reception of a NACK on at least one of the one or more carriers of the plurality of carriers; and cancel one or more remaining transmissions or re-transmissions for the one or more packets scheduled on the one or more carriers of the plurality of carriers, in response to a determination of at least one of: reception of the ACK from at least one of the one or more target receiver UEs, or non-reception of the NACK on the at least one of the one or more carriers of the plurality of carriers.

According to some embodiments of the present disclosure, there is provided a non-transitory computer-readable medium storing instructions that are executable by one or more processors of a first UE to perform a method. The method includes transmitting, by the first UE, one or more packets on one or more carriers of a plurality of carriers that are to be used for a sidelink carrier aggregation; determining, by the first UE, at least one of: reception of an ACK from each of one or more target receiver UEs, or non-reception of a NACK on at least one of the one or more carriers of the plurality of carriers; and canceling, by the first UE, one or more remaining transmissions or re-transmissions for the one or more packets scheduled on the one or more carriers of the plurality of carriers, in response to a determination of at least one of: reception of the ACK from at least one of the one or more target receiver UEs, or non-reception of the NACK on the at least one of the one or more carriers of the plurality of carriers.

### BRIEF DESCRIPTION OF DRAWINGS

FIG. 1 is a flow chart illustrating a method for resource selection in a sidelink communication, consistent with some embodiments of the present disclosure.

FIG. 2 is a schematic diagram illustrating a resource candidate determination procedure according to the method of FIG. 1, consistent with some embodiments of the present disclosure.

FIG. 3 is a flow chart illustrating a method for resource selection in a sidelink communication, consistent with some embodiments of the present disclosure.

FIG. 4A is a schematic diagram illustrating a resource candidate determination procedure according to the method of FIG. 3, consistent with some embodiments of the present disclosure.

FIG. 4B is a table showing a correspondence between sub-carrier spacing (SCS) and a subset of resources according to the method of FIG. 3, consistent with some embodiments of the present disclosure.

FIG. 5 is a schematic diagram illustrating an exemplary procedure for sidelink carrier aggregation, consistent with some embodiments of the present disclosure.

FIG. 6 is a schematic diagram illustrating another exemplary procedure for sidelink carrier aggregation, consistent with some embodiments of the present disclosure.

FIG. 7 is a flow chart illustrating a method for sidelink carrier aggregation, consistent with some embodiments of the present disclosure.

FIG. 8 is a block diagram of a UE, consistent with some embodiments of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the present disclosure. Instead, they are merely examples of systems, apparatuses, and methods consistent with aspects related to the present disclosure as recited in the appended claims.

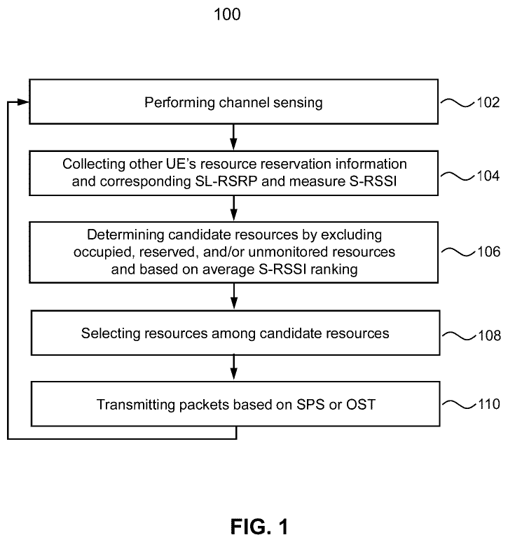

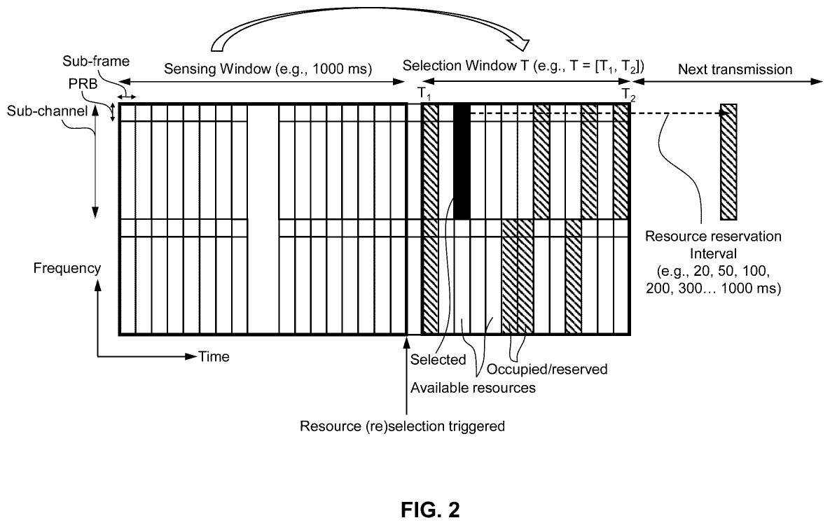

FIG. 1 is a flow chart illustrating a method 100 (referred to as the “first method” in this disclosure) for resource selection in a sidelink communication; and FIG. 2 is a schematic diagram illustrating a resource candidate determination procedure according to the first method, consistent with some embodiments of the present disclosure. The method 100 may be performed by a UE in a sidelink communication. For example, the method 100 may be performed by a vehicle in a V2X communication. The method 100 may be performed under a mode (referred to as the “first mode” in this disclosure) that employs discrete Fourier transform spread orthogonal frequency division multiplexing (DFT-s-OFDM) for sidelink at the physical (PHY) layer. An example of the first mode is the 3GPP Release 14/15 Long-Term Evolution (LTE) V 2 X PC 5 mode 4.

As shown in FIG. 2, in the first mode, the time-frequency radio resources are divided into sub-frames in the time domain and sub-channels in the frequency domain. In an embodiment, the first mode may only support 15 kHz sub-carrier spacing. Each sub-frame may be 1 ms length and may consist of 14 DFT-s-OFDM symbols. Each sub-channel may consist of multiple contiguous physical resource blocks (PRBs), where each PRB occupies 180 kHz and consists of 12 subcarriers with 15 kHz SCS. The size of sub-channel (i.e., the number of PRBs per sub-channel) may be configurable or preconfigurable. To cope with high Doppler caused by high relative speed in vehicular scenarios, the density of DMRS, which is used for frequency offset compensation and channel estimation, may be set to four per sub-frame. Each UE may broadcast data (e.g., transport block (TB)) in the PSSCH and SCI in the physical sidelink control channel (PSCCH). The PSCCH may occupy two contiguous PRBs. The number of PRBs for PSSCH may be configurable or preconfigurable. The SCI format may contain information to decode the corresponding TB in PSSCH and facilitate UE autonomous resource selection. As shown in FIG. 2, the resource reservation interval can be set to one of the allowed values (e.g., 20, 50, 100, 200, 300 . . . 1000 ms). PSCCH and the corresponding PSSCH may be transmitted in the same sub-frame in either adjacent or non-adjacent PRBs in the frequency domain.

Referring to FIG. 1, method 100 includes a step 102 of performing a channel sensing (e.g., background sensing or any other type of full sensing or partial sensing). For example, as shown in FIG. 2, for resource selection, a UE may perform a channel sensing in a sensing window (e.g., 1000 ms) to collect another UE's resource reservation information. The sensing window can be any time duration, depending on the UE implementation.

Referring back to FIG. 1, the method 100 includes a step 104 of collecting another UE's resource reservation information and corresponding SL-RSRP, and measuring sidelink received signal strength indicator (S-RSSI). For example, the UE may collect resource reservation information of other UEs and the corresponding SL-RSRPs. The UE may also measure the S-RSSI using received sidelink signals. The UE may decode received SCI included in the received sidelink signals to identify candidate resources in a selection window T (e.g., T=[T₁, T₂], where T₁≤4 ms, and 20≤T₂=100 ms), as shown in FIG. 2. The selection of the T₁ and T₂ values depends on the UE implementation.

The method 100 includes a step 106 of determining candidate resources by excluding occupied, reserved, and/or unmonitored resources and based on an average S-RSSI ranking. For example, as shown in FIG. 2, once the resource selection or reselection is triggered, the UE may exclude some sub-frames from the selection window. The excluded sub-frames may be the resources not monitored in the sensing window. The UE may not sense these resources due to, for example, its own transmission (e.g., half-duplex constraint). The UE may further exclude resources occupied or reserved by other UEs from the selection window if the corresponding SL-RSRP exceeds a configured or preconfigured SL-RSRP exclusion threshold. After resource exclusion, the number of candidate resources may be at least 20% of the total number of resources in the selection window. Otherwise, the UE may increase the SL-RSRP exclusion threshold by, for example, 3 dB until the candidate resources reaches at least 20% of the total resources. The UE may further calculate the corresponding S-RSSI of each sub-channel resource as a linear average over the S-RSSIs of the monitored resources with a certain interval (e.g., the averaging interval is 100 ms for a resource reservation interval of greater than or equal to 100 ms). The UE may determine, for example, 20% best resources in terms of lowest average S-RSSI as the candidate resources among the total resources in the selection window. The UE may use the 20% resources with the lowest average S-RSSI based on S-RSSI ranking as candidate resources.

The method 100 includes a step 108 of selecting resources among candidate resources. The selection of the resources among the candidate resources may be a random selection. For example, as shown in FIG. 2, the UE may select a single-subframe resource in a uniformly random manner among candidate single-subframe resources.

The selected frequency resource can be used for multiple times with a fixed time interval for subsequent transmissions (this scheme is referred to as SPS in this disclosure) or only once (this scheme is referred to as OST in this disclosure).

The method 100 includes a step 110 of transmitting packets based on SPS or OST. The packets can be initial or retransmitted packets. For example, the UE may transmit an initial packet using the selected resources. For another example, the UE may retransmit a packet up to one time without feedback from receiver UEs to improve reliability of the transmission (this is referred to as “blind HARQ retransmission” in 3GPP and this disclosure). After the transmission, the method may start again from the step 102.

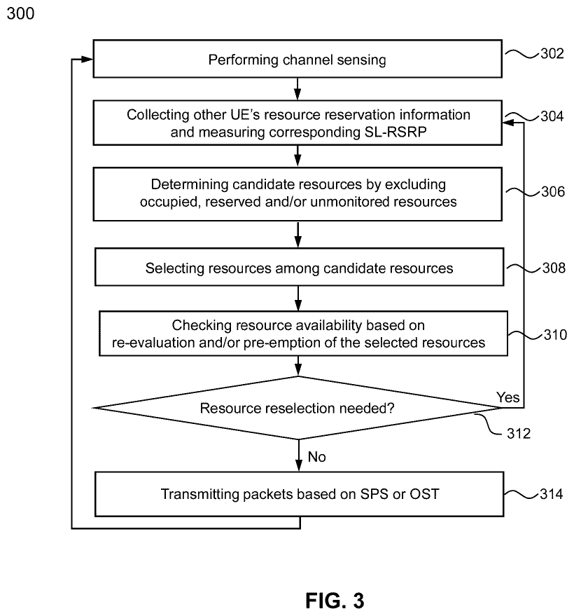

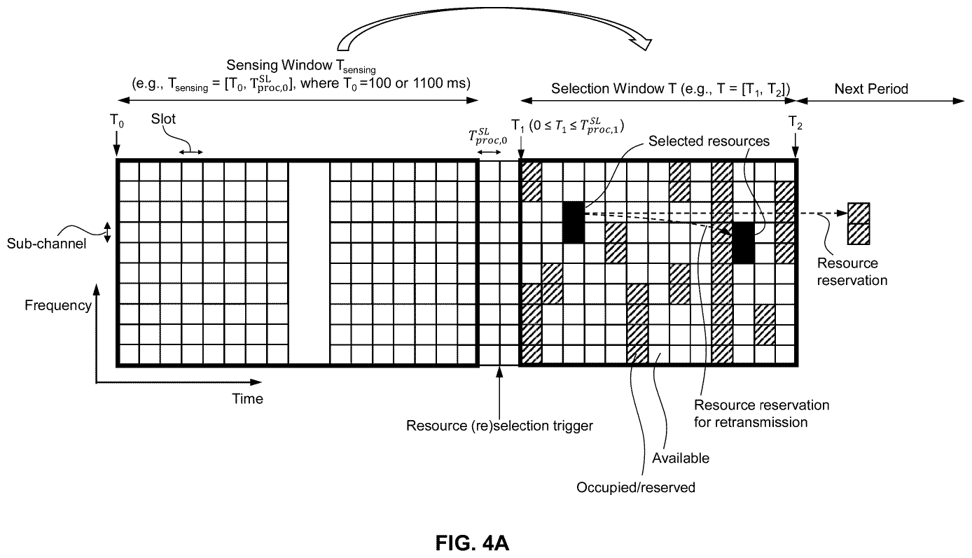

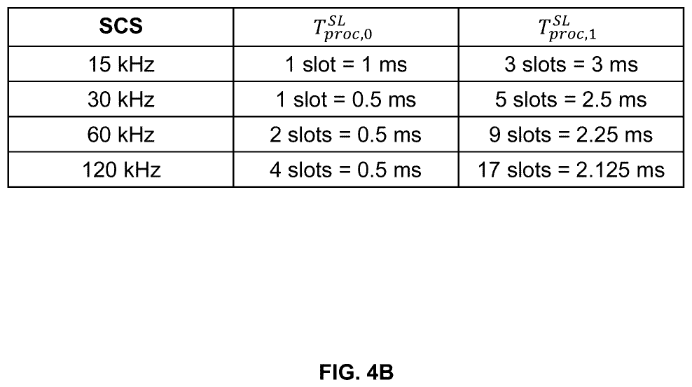

FIG. 3 is a flow chart illustrating a method 300 (referred to as the “second method” in this disclosure) for resource selection in a sidelink communication; FIG. 4A is a schematic diagram illustrating a resource candidate determination procedure according to the second method; and FIG. 4B is a table showing a correspondence between sub-carrier spacing (SCS) and a subset of resources according to the second method, consistent with some embodiments of the present disclosure. The method 300 may be performed by a UE in a sidelink communication. For example, the method 300 may be performed by a vehicle in a V2X communication. The method 300 may be performed under a mode (referred to as the “second mode” in this disclosure) that employs orthogonal frequency division multiplexing (OFDM) at the PHY layer for a sidelink communication. An example of the second mode is the 3GPP Release 16/17 5G NR-V2 X PC5 mode 2.

As shown in FIG. 4A, in the second mode, the time-frequency radio resources are divided into slots in the time domain and sub-channels in the frequency domain. In an embodiment, the second mode may support sub-carrier spacings (SCSs) of 15 2^{μ} kHz, where μ is the OFDM numerology μ∈{0, 1, 2, 3, 4}. For sub-6 GHz frequency, SCSs of 15, 30, and 60 kHz (i.e., μ∈{0, 1, 2}) may be supported, whereas for above 6 GHz frequency, SCSs of 60, 120, and 240 kHz (i.e., μ∈{2, 3, 4}) may be supported. Each slot is 1/2^{μ} ms length and consists of 14 OFDM symbols. Each sub-channel may consist of multiple contiguous PRBs, where each PRB occupies 180 2^{μ} kHz and consists of 12 subcarriers with 15 2⁸² kHz SCS. The size of sub-channel (i.e., the number of PRBs per sub-channel) is configurable or preconfigurable. To support multiple SCSs and different Doppler spreads, multiple DMRS density options (2-4 DMRS symbols per slot) are supported. Each UE may transmit a first stage SCI in the PSCCH and data (TB), and a second stage SCI in the PSSCH. HARQ feedback (e.g., ACK/NACK or NACK only) may be transmitted in the PSFCH.

FIG. 4B shows the correspondence among SCS and parameters for the sensing window and selection window (T^{SL}_{proc,0} and T^{SL}_{proc,1}), consistent with some embodiments of the present disclosure. For example, when the SCS is 15 kHz, as shown in the second and third columns of FIG. 4B, T^{SL}_{proc,0} corresponds to 1 ms, and T^{SL}_{proc,1} correspond to 3 ms. As another example, when the SCS is 30 kHz, T^{SL}_{proc,0} corresponds to 0.5 ms, and T^{SL}_{proc,1} correspond 2.5 ms.

Referring back to FIG. 3, the method 300 includes a step 302 of performing a channel sensing (e.g., a background sensing or any other type of full sensing or partial sensing). For example, as shown in FIG. 4A, a UE may perform a channel sensing in a sensing window T_{sensing} (e.g., T_{sensing}=[T₀, T^{SL}_{proc,0}], where T₀=100 or 1100 ms and T^{SL}_{proc,0} is given in FIG. 4B) to collect another UE's resource reservation information. The channel sensing with a sensing window of 100 ms may be for an aperiodic traffic, while the channel sensing with a sensing window of 1100 ms may be for a periodic traffic.

The method 300 includes a step 304 of collecting another UE's resource reservation information and measuring corresponding SL-RSRPs. For example, as shown in FIG. 4A, the UE may perform a channel sensing in the sensing window and collect another UE's resource reservation information based on SCI decoding to identify candidate resources. In an embodiment, in order to perform the channel sensing and obtain information to receive other UEs' packets, the UE decodes SCI first. The SCI decoding may include two stages: a first stage SCI (SCI format 1-A) and a second stage SCI (SCI format 2-A or 2-B) as defined in 3GPP specifications. The first stage SCI may carry resource reservation information for future transmissions, information about resource allocation, MCS for PSSCH, DMRS pattern, and the second stage SCI format, etc. The second stage SCI may carry control information for HARQ procedures, source/destination IDs, information for distance-based groupcast (e.g., UE's zone ID and communication range requirement), etc. Based on the resource reservation information contained in the first stage SCI, the UE may avoid using time and/or frequency resources reserved by other UEs when the UE performs resource selection or reselection.

The method 300 may support inter-UE coordination in which a first UE (UE-A) sends coordination information about resources to a second UE (UE-B), and the UE-B utilizes that information for its resource selection or reselection. In some embodiments, the UE may support a first inter-UE coordination scheme. In the first inter-UE coordination scheme, the UE may receive from another UE indications of resources that are preferred to be included in the UE's selected or reselected resources, or preferred to be excluded. In an embodiment, when an indication of resources indicates inclusion of given resources, the UE may solely rely on those resources, if the indication does not support sensing and/or resource exclusion. In an embodiment, the UE may also combine the indication of resources with resources identified by its own sensing procedure before making a final selection. The UE may receive the indication via MAC CE and/or 2nd-stage SCI. In some embodiments, the UE may support a second inter-UE coordination scheme. In the second inter-UE coordination scheme, the UE may receive an indication that resources reserved for the UE's transmission will be, or could be, subject to conflict with a transmission from another UE. In this case, the UE may re-select new resources. The UE may receive indication via PSFCH. The UE may use a mapping table that defines a mapping rule between PSSCH allocation (slots and sub-channels) and PSFCH resources. Using the mapping table, the UE (and the transmitter UE) can determine the PSSCH allocation (slot(s) and sub-channel(s)) that the information in the PSFCH resource refers to. When more than one sub-channel is reserved in the PSSCH, multiple PSFCH resources may be used. The mapping table may be pre-defined, pre-configured at the UE, or configured by a network node.

The method 300 includes a step 306 of determining candidate resources by excluding occupied, reserved, and/or unmonitored resources. For example, the UE may exclude unmonitored slots from the selection window T (e.g., T=[T₁, T₂], where 0≤T≤T^{SL}_{proc,1} ms, T^{SL}_{proc,1} is given in FIG. 4B, and T₂ may be set based on the remaining packet delay budget). The UE may fail to sense the unmonitored slots in the sensing window due to, for example, its own transmission (e.g., half-duplex constraint). The UE may further exclude resources occupied or reserved by other UEs from the selection window if the corresponding SL-RSRP exceeds a configured or preconfigured SL-RSRP exclusion threshold. After resource exclusion, the number of candidate resources may be at least X% of the total number of resources in the selection window. Otherwise, UE may increase the SL-RSRP exclusion threshold by, for example, 3 dB until at least X% resources are obtained, where X may be configured or preconfigured from {20, 35, 50}%.

The method 300 includes a step 308 of selecting resources among candidate resources. The selection may be a random selection. For example, as shown in FIG. 4A, the UE may select resources among candidate resources in the selection window. The selected frequency resource can be used multiple times with a fixed time interval for SPS or only once for OST.

The method 300 includes a step 310 of checking resource availability based on re-evaluation and/or pre-emption of the selected resources. This step may be performed for the late-arriving packets (e.g., aperiodic packets) after resource selection and before the packet transmission.

The method 300 includes a step 312 of determining whether a resource reselection is needed. If it is determined that a resource reselection is needed, the method may iterate from the step 304. On the other hand, if it is determined that a resource reselection is not needed, the method may proceed with a step 314 of transmitting packets based on SPS or OST. The packets may be initial packets or retransmitted packets. The UE may also retransmit packets multiple times (e.g., HARQ retransmissions) with or without feedback from receiver UEs to improve reliability of the transmission. After the step 314, the method iterates from the step 302.

At least some embodiments of the present disclosure are directed to carrier aggregation in sidelink communications that support the first mode described above with respect to FIGS. 1-2, and/or the second mode described above with respect to FIGS. 3, 4A-4B. Carrier aggregation is desired in sidelink communications because it allows for high throughput and reliable communication. The above-noted first mode may only support broadcast, while above-noted second mode may support broadcast, unicast, and groupcast with HARQ feedback.

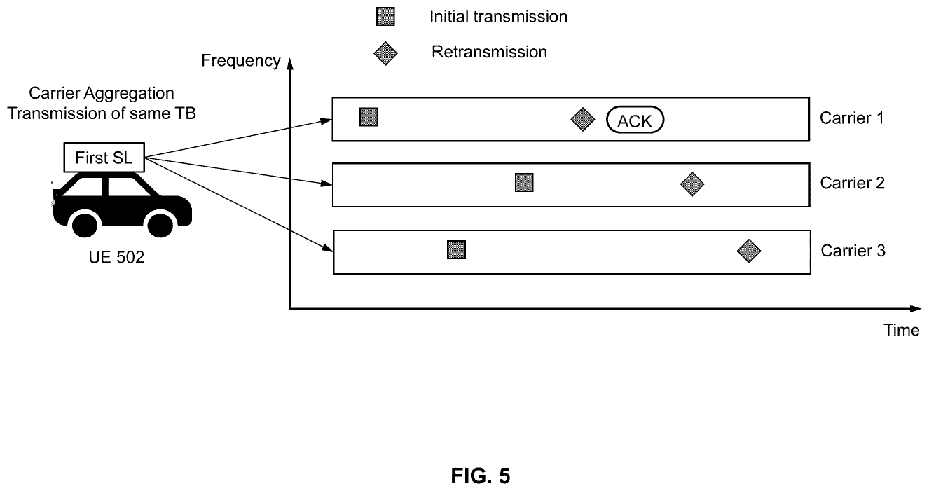

FIG. 5 is a schematic diagram illustrating an exemplary sidelink carrier aggregation, consistent with some embodiments of the present disclosure. Referring to FIG. 5, a UE 502 in a first sidelink communication implements carrier aggregation in order to achieve high throughput and improved reliability. The UE 502 may be a transmitter (Tx) UE in the first sidelink communication. For example, in order to increase throughput, the UE 502 may transmit multiple media access control protocol data units (MAC PDUs) on multiple sidelink carriers. In order to improve reliability, the UE 502 may perform packet data convergence protocol (PDCP) duplication, in which the same PDCP packet is transmitted on multiple sidelink carriers. For example, as shown in FIG. 5, the UE 502 uses aggregation of three sidelink carriers, i.e., a carrier 1, a carrier 2, and a carrier 3 to transmit data (e.g., transport block). The first sidelink communication may support the second mode described above. For example, the first sidelink communication may be an NR sidelink communication. The UE 502 may transmit the same PDCP packet or transport block on each of the three carriers to improve reliability.

The UE 502 may select or reselect the three sidelink carriers for transmission based on a measured channel busy ratio (CBR) for each sidelink carrier. For example, the UE 502 may consider a plurality of sidelink carriers as candidate sidelink carriers if the measured CBR of each of the plurality of sidelink carriers is below a CBR threshold. The CBR threshold may be configured by a network node or pre-configured at the UE 502. The CBR threshold may be associated with priority of the sidelink transmission. The UE 502 may select the three sidelink carriers among the plurality of candidate sidelink carriers with an increasing order of CBR from the lowest CBR. The UE 502 may decide the number (e.g., three) of sidelink carriers to be aggregated based on the UE capability. The UE 502 may select resources independently on each sidelink carrier based on a sensing and resource selection procedure. The UE 502 may use the selected sidelink carriers at least until a carrier re-selection is triggered.

A unicast or groupcast is usually associated with ACK/NACK feedback. For example, a transmitter UE transmitting data via a unicast or a groupcast Option 2 usually involves ACK feedback from one or more receiver UEs, and a transmitter UE transmitting data via groupcast Option 1 usually involves NACK feedback. If the transmitter UE does not receive ACK or NACK feedback from the one or more receiver UEs, the transmitter UE retransmits the same data to the one or more receiver UEs until the transmitter UE receives ACK/NACK feedback, even if communication on at least one of the sidelink carriers is successful. For example, as shown FIG. 5, the carrier 1 is for unicast and the UE 502 receives an ACK after a first retransmission, indicating at least the communication on the carrier 1 is successful. But the UE 502 keeps performing retransmissions on the carrier 2 and the carrier 3 (the retransmissions on the carriers 2 and 3 occur after the reception of ACK on the carrier 1), until the UE 502 receives ACK or no NACK on the carrier 2 and the carrier 3. This causes unnecessary transmissions or retransmission, and thus reduces spectral efficiency. At least some embodiments of the present disclosure resolve the above-noted issues in sidelink carrier aggregation for unicast and groupcast.

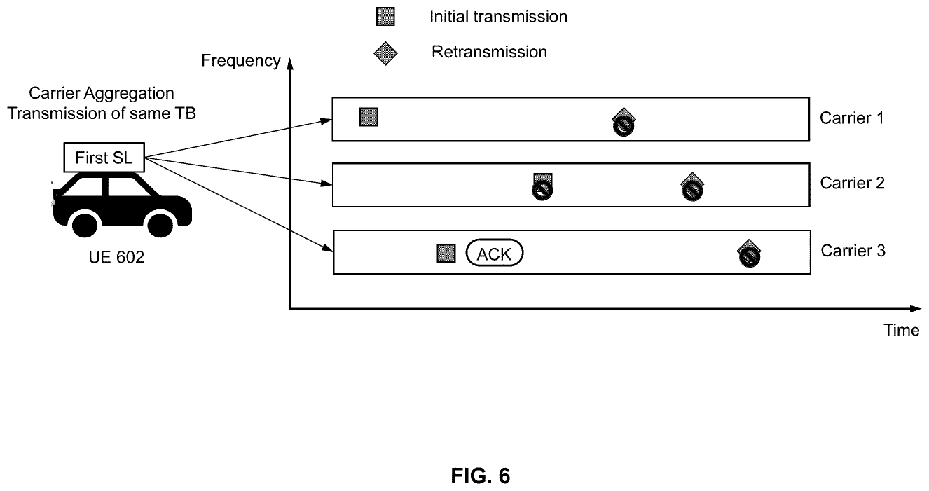

FIG. 6 is a schematic diagram illustrating another exemplary procedure for a sidelink carrier aggregation, consistent with some embodiments of the present disclosure. Referring to FIG. 6, a UE 602 in a first sidelink communication uses carrier aggregation in order to achieve high throughput and/or improved reliability. The UE 602 may be a Tx UE in the first sidelink communication. Similar to the UE 502 of FIG. 5, the UE 602 uses aggregation of three sidelink carriers, i.e., a carrier 1, a carrier 2, and a carrier 3 to transmit a transport block. The UE may select the carriers 1-3 based on the procedure described with respect to FIG. 5. For the sake of brevity, the procedure of the carrier selection is omitted here. The first sidelink communication may support the second mode described above. For example, the first sidelink communication may be an NR sidelink communication. The UE may transmit the same transport block on each of the three sidelink carriers to improve reliability.

Instead of continuously transmitting or retransmitting the same transport block (which is the case in FIG. 5), in FIG. 6, the UE 602 may cancel the remaining transmissions or retransmissions for the same transport block on all the sidelink carriers if the UE 602 determines that communication of at least one of the three sidelink carriers is successful. To this end, the UE 602 may use MAC-level packet duplication instead of PDCP packet duplication so that the MAC layer is aware that packets transmitted over multiple sidelink carriers include the same TB. For example, as shown in FIG. 6, the carrier 3 is for unicast and the UE receives an ACK after an initial transmission, indicating at least the communication on the carrier 3 is successful. In this case, the UE cancels the initial transmission on the carrier 2 and all the retransmissions on the carriers 1-3.

In this way, the disclosed methods may minimize unnecessary transmissions and/or retransmission and thus improve spectral efficiency in sidelink carrier aggregation for unicast and groupcast.

While the above examples in the present disclosure relate to carrier aggregation of three sidelink carriers, the application of the disclosed methods are not so limited. The number of aggregated carriers can be any number, depending on the UE capability. The methods described in this disclosure can be applied to any sidelink communications (or radio access technologies (RATs)), for example, a future generation (6th generation (6G), 7th generation (7G), or any future generation) sidelink communications. The methods described in this disclosure can also be applied to other systems, for example, carrier aggregation in the systems that comply with IEEE standards.

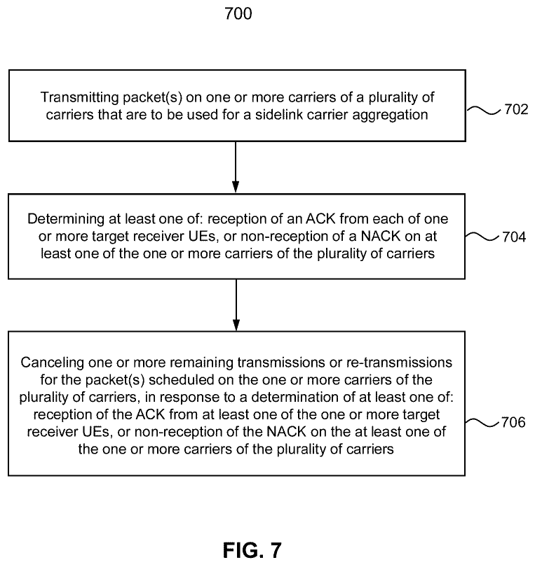

FIG. 7 is a flow chart illustrating a method 700 for sidelink carrier aggregation, consistent with some embodiments of the present disclosure. The method 700 may be performed by a UE in a sidelink communication, such as the UE 602 of FIG. 6.

The method 700 includes a step 702 of transmitting, by a first UE, one or more packets on one or more carriers of a plurality of carriers that are to be used for a sidelink carrier aggregation. For example, a first UE, such as the UE 602 of FIG. 6, may transmit the packet(s) on one or more carriers of a plurality of carriers. The plurality of carriers forms a carrier aggregation. In some embodiments, the first UE may transmit the same packet(s) on each of the plurality of carriers to improve reliability. The one or more packets may be a signal or data (e.g., transport block). For example, in an embodiment, the one or more packets is one or more transport blocks in MAC layer. The plurality of carriers may be a plurality of carriers for the same RAT or a plurality of carriers for different RATs.

In some embodiments, the first UE may select the one or more carriers of the plurality of carriers on which the one or more packets is to be transmitted. The first UE may select the one or more carriers of the plurality of carriers on which the one or more packets is to be transmitted based on at least one of: (a) a priority of each of the one or more carriers; (b) a traffic load for each of the one or more carriers; or (c) a number of unsuccessful receptions in X slots on each of the one or more carriers, where the X is a natural number. The X value may be configured by a network node or pre-configured at the first UE.

In some embodiments, the first UE may further adjust a number of the selected one or more carriers of the plurality of carriers on which the one or more packets is to be transmitted. For example, the first UE may dynamically adjust the number of the selected one or more carriers of the plurality of carriers on which the one or more packets is to be transmitted based on whether a metric calculated from CBRs associated with candidate carriers of the plurality of carriers is greater than a first threshold. The first threshold may be configured by a network node or pre-configured at the first UE. For another example, the first UE may dynamically adjust the number of the selected one or more carriers of the plurality of carriers on which the one or more packets is to be transmitted based on whether the number of unsuccessful receptions on the one or more carriers is greater than a second threshold. The second threshold may be configured by a network node or pre-configured at the first UE. The second threshold may be a function of a priority of each of the one or more carriers and the CBR associated with each of the one or more carriers. The metric calculated from the CBRs associated with the candidate carriers may include at least one of: a maximum of the CBRs of the candidate carriers, a minimum of the CBRs of the candidate carriers, an average of the CBRs of the candidate carriers, or a median value of the CBRs of the candidate carriers.

In some embodiments, the first UE may further exclude at least one carrier from the candidate carriers in response to a determination that the number of unsuccessful receptions in the X slots on each of the one or more carriers is greater than a threshold. The threshold may be configured by a network node or pre-configured at the first UE.

The method 700 includes a step 704 of determining, by the first UE, at least one of: reception of an ACK from each of one or more target receiver UEs, or non-reception of a NACK on at least one of the one or more carriers of the plurality of carriers. The ACK and the NACK may be HARQ feedback signals. The ACK or the NACK may be received by the first UE over a PSFCH. In some embodiments, the first UE may determine at least one of: the reception of an ACK from each of one or more target receiver UEs, or the non-reception of a NACK on at least one of the one or more carriers of the plurality of carriers, at one or more HARQ feedback occasions or before a sidelink timer expires. The sidelink timer can be configured by a network node or preconfigured at the first UE.

The method 700 includes a step 706 of canceling, by the first UE, one or more remaining transmissions or re-transmissions for the one or more packets scheduled on the one or more carriers of the plurality of carriers, in response to a determination of at least one of: reception of the ACK from at least one of the one or more target receiver UEs, or non-reception of the NACK on the at least one of the one or more carriers of the plurality of carriers. In some embodiments, the first UE may cancel the one or more remaining transmissions or re-transmissions for the one or more packets on the one or more carriers of the plurality of carriers, in response to a determination of reception of the ACK from each of the one or more target receiver UEs on one or more specific carriers of the plurality of carriers. The one or more specific carriers may be configured by a network node or pre-configured at the first UE.

In some embodiments, the first UE may cancel the one or more remaining transmissions or re-transmissions for the one or more packets on the one or more carriers of the plurality of carriers, in response to a determination of non-reception of the NACK on one or more specific carriers of the plurality of carriers. The one or more specific carriers may be configured by a network node or pre-configured at the first UE.

In some embodiments, the first UE may cancel the one or more remaining transmissions or re-transmissions for the one or more packets on the one or more carriers of the plurality of carriers, in response to (a) a determination of reception of the ACK from each of the one or more target receiver UEs on one or more specific carriers of the plurality of carriers, or (b) a determination of non-reception of the NACK on the one or more specific carriers of the plurality of carriers. The one or more specific carriers may be configured by a network node or pre-configured at the first UE. The first UE may select the one or more specific carriers based on at least one of: (a) a highest CBR level associated with the one or more carriers of the plurality of carriers; (b) a highest sidelink reference signal received power (RSRP) level associated with the one or more carriers of the plurality of carriers; or (c) an anchor carrier that is a pre-selected, configured, or pre-configured.

In some embodiments, the first UE may cancel the one or more remaining transmissions or re-transmissions for the one or more packets on one or more first carriers of the plurality of carriers, in response to a determination of reception of the ACK or non-reception of the NACK from the at least one of the one or more target receiver UEs on one or more second carriers that are different from the one or more first carriers of the plurality of carriers. The one or more second carriers may be configured by a network node or pre-configured at the first UE. In some embodiments, the first UE may cancel the one or more remaining transmissions or re-transmissions for the one or more packets on one or more first carriers of the plurality of carriers, in response to a determination of non-reception of the NACK on the one or more second carriers that are different from the one or more first carriers of the plurality of carriers.

In some embodiments, the first UE may cancel the one or more remaining transmissions or re-transmissions for the one or more packets on the one or more carriers of the plurality of carriers, in response to a determination of reception of the ACK from at least one specific target receiver UE among the one or more target receiver UEs. The at least one specific target receiver UE may be configured by a network node or pre-configured at the first UE.

In some embodiments, the first UE may cancel the one or more remaining transmissions or re-transmissions for the one or more packets on the one or more carriers of the plurality of carriers, in response to a determination of reception of the ACK from a specific number of UEs from among the one or more target receiver UEs. The specific number may be configured by a network node or pre-configured at the first UE. In some embodiments, the first UE may cancel the one or more remaining transmissions or re-transmissions for the one or more packets on the one or more carriers of the plurality of carriers, in response to a determination of reception of a quantity of the NACK on at least one of the plurality of carriers. The quantity may be configured by a network node or pre-configured at the first UE.

In some embodiments, the first UE may cancel the one or more remaining transmissions or re-transmissions for the one or more packets on the one or more carriers of the plurality of carriers, in response to: (a) a determination of reception of the ACK from each of the one or more target receiver UEs; or (b) a determination of non-reception of the NACK on the one or more carriers of the plurality of carriers.

In some embodiments, the first UE may utilize the resources associated with the canceled transmissions or retransmissions for other purposes. For example, the first UE may schedule transmission of one or more other packets to one or more other target receiver UEs, using resources associated with the canceled one or more remaining transmissions or re-transmissions for the packet.

In some embodiments, the first UE does not make reservation of resources for the one or more re-transmissions for the one or more packets on the one or more carriers of the plurality of carriers, in response to a determination of reception of the ACK or non-reception of the NACK from a first number of target receiver UEs among the one or more target receiver UEs. The first number may be greater than a threshold number. The threshold number may be configured by a network node or pre-configured at the first UE. The threshold number may be a function of a priority of each of the one or more carriers, or a function of a CBR associated with each of the one or more carriers. The threshold number may also be a function of a priority of each of the one or more carriers, and a CBR associated with each of the one or more carriers.

In some embodiments, the first UE may dynamically switch between a groupcast and a unicast based on a number of the one or more target receiver UEs with unsuccessful receptions on the one or more carriers of the plurality of carriers. For example, when the first UE performs a groupcast, the first UE may switch from the groupcast to a unicast, in response to a determination that the number of the one or more target receiver UEs with unsuccessful receptions is smaller than a threshold. The threshold may be configured by a network node or pre-configured at the first UE. The first UE may further perform a link adaptation for each of one or more unicast links. For example, the first UE may perform a MCS adjustment on the one or more unicast links. The first UE may also apply a different block error rate (BLER) target for each of the one or more unicast links used for packet duplication or for transport block transmission. The first UE may further cancel the one or more remaining transmissions or re-transmissions for the packet, in response to a determination that a number of NACKs corresponds to a higher BLER than an initial BLER target of a carrier.

In some embodiments, the one or more carriers of the plurality of carriers may be a first set of carriers for the packet(s) transmission in which HARQ feedback is enabled. In this case, the first UE may perform one or more blind re-transmissions of the one or more packets using a second set of carriers of the plurality of carriers. The second set of carriers may be different from the first set of carriers. The first UE may further stop the one or more blind re-transmissions in response to a determination of reception of the ACK on at least one of the first set of carriers. The first UE may perform the packet(s) transmission with the first set of carriers and the one or more blind re-transmissions with the second set of carriers are performed over a PSSCH.

In some embodiments, the one or more carriers of the plurality of carriers may be licensed carriers for the packet(s) transmission in which HARQ feedback is enabled. In this case, the first UE may perform one or more blind re-transmissions of the one or more packets using one or more unlicensed carriers. The first UE may further stop the one or more blind re-transmissions in response to a determination of reception of the ACK on at least one of the licensed carriers. The first UE may perform the packet(s) transmission on the licensed carriers and the one or more blind re-transmissions on the one or more unlicensed carriers over a PSSCH.

In some embodiments, the first UE may transmit one or more indications about the cancellation of one or more resource reservations already indicated on the one or more carriers of the plurality of carriers. The first UE may transmit the one or more indications over at least one of: a PSCCH, a PSSCH, a PSFCH, a MAC CE, or higher layers such as the network layer or transport layer or an application layer.

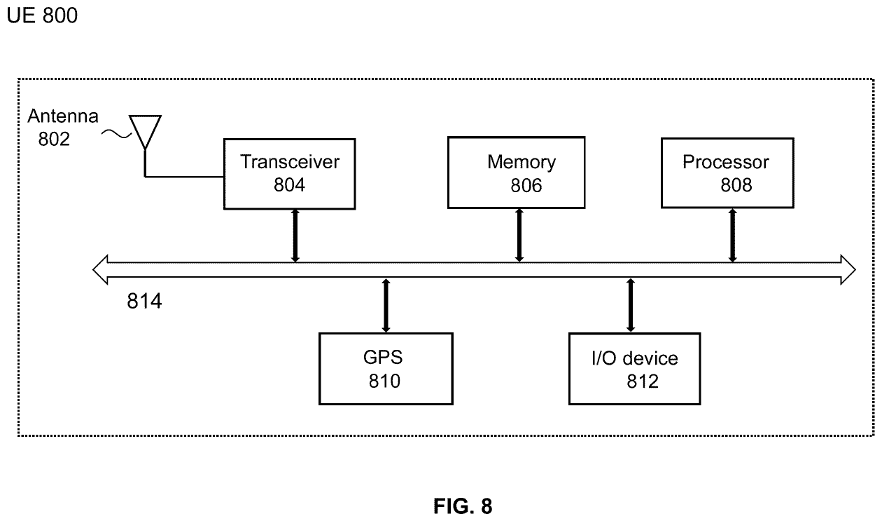

FIG. 8 is a block diagram of a UE 800, consistent with some embodiments of the present disclosure. The UE 800 may support the above-noted first mode and/or the second mode. UE 800 may be mounted in a moving vehicle or in a fixed position. UE 800 may take any form, including but not limited to, a vehicle, a component mounted in a vehicle, a road-side unit, a laptop computer, a wireless terminal including a mobile phone, a wireless handheld device, or wireless personal device, or any other form. Referring to FIG. 8, the UE 800 may include antenna 802 that may be used for transmission or reception of electromagnetic signals to/from a base station or other UEs. The Antenna 802 may include one or more antenna elements and may enable different input-output antenna configurations, for example, multiple input multiple output (MIMO) configuration, multiple input single output (MISO) configuration, and single input multiple output (SIMO) configuration. In some embodiments, the antenna 802 may include multiple (e.g., tens or hundreds) antenna elements and may enable multi-antenna functions such as beamforming. In some embodiments, the antenna 802 is a single antenna.

The UE 800 may include a transceiver 804 that is coupled to the antenna 802. The transceiver 804 may be a wireless transceiver at the UE 800 and may communicate bi-directionally with a base station or other UEs. For example, the transceiver 804 may receive/transmit wireless signals from/to a base station via downlink/uplink communication. The transceiver 804 may also receive/transmit wireless signals from/to another UE or road side unit via sidelink communication. The transceiver 804 may include a modem to modulate the packets and provide the modulated packets to the antenna 802 for transmission, and to demodulate packets received from the antenna 802.

The UE 800 may include a memory 806. The memory 806 may be any type of computer-readable storage medium including volatile or non-volatile memory devices, or a combination thereof. The computer-readable storage medium includes, but is not limited to, non-transitory computer storage media. A non-transitory storage medium may be accessed by a general purpose or special purpose computer. Examples of non-transitory storage medium include, but are not limited to, a portable computer diskette, a hard disk, random access memory (RAM), read-only memory (ROM), an erasable programmable read-only memory (EPROM), electrically erasable programmable ROM (EEPROM), a digital versatile disk (DVD), flash memory, compact disk (CD) ROM or other optical disk storage, magnetic disk storage or other magnetic storage devices, etc. A non-transitory medium may be used to carry or store desired program code means (e.g., instructions and/or data structures) and may be accessed by a general-purpose or special-purpose computer, or a general-purpose or special-purpose processor. In some examples, the software/program code may be transmitted from a remote source (e.g., a website, a server, etc.) using a coaxial cable, fiber optic cable, twisted pair, digital subscriber line (DSL), or wireless technologies such as infrared, radio, and microwave. In such examples, the coaxial cable, fiber optic cable, twisted pair, DSL, or wireless technologies such as infrared, radio, and microwave are within the scope of the definition of medium. Combinations of the above examples are also within the scope of computer-readable medium.

The memory 806 may store information related to identities of UE 800 and the signals and/or data received by antenna 802. The memory 806 may also store post-processing signals and/or data. The memory 806 may also store computer-readable program instructions, mathematical models, and algorithms that are used in signal processing in receiver 804 and computations in processor 808. The memory 806 may further store computer-readable program instructions for execution by processor 808 to operate UE 800 to perform various functions described in this disclosure. In some examples, the memory 806 may include a basic input/output system (BIOS) which may control basic hardware or software operation such as the interaction with peripheral components or devices. In some embodiments, the memory 806 includes both LTE sidelink and NR sidelink modules. In some embodiments, the memory 806 includes an NR sidelink module only. In some embodiments, the memory 806 includes an LTE sidelink module only.

The computer-readable program instructions of the present disclosure may be assembler instructions, instruction-set-architecture (ISA) instructions, machine instructions, machine-dependent instructions, microcode, firmware instructions, state-setting data, or source code or object code written in any combination of one or more programming languages, including an object-oriented programming language, and conventional procedural programming languages. The computer-readable program instructions may execute entirely on a computing device as a stand-alone software package, or partly on a first computing device and partly on a second computing device remote from the first computing device. In the latter scenario, the second, remote computing device may be connected to the first computing device through any type of network, including a local area network (LAN) or a wide area network (WAN).

The UE 800 may include a processor 808 that may include a hardware device with processing capabilities. The processor 808 may include at least one of a general-purpose processor, a digital signal processor (DSP), a central processing unit (CPU), a microcontroller, an application specific integrated circuit (ASIC), a field programmable gate array (FPGA), a programmable logic device, a discrete gate or transistor logic component, a discrete hardware component, or other programmable logic device. Examples of the general-purpose processor include, but are not limited to, a microprocessor, any conventional processor, a controller, a microcontroller, or a state machine. In some embodiments, the processor 808 may be implemented using a combination of devices (e.g., a combination of a DSP and a microprocessor, multiple microprocessors, one or more microprocessors in conjunction with a DSP core, or any other such configuration). The processor 808 may receive, from transceiver 804, downlink signals or sidelink signals and further process the signals. The processor 808 may also receive, from transceiver 804, data packets and further process the packets. In some embodiments, the processor 808 may be configured to operate a memory using a memory controller. In some embodiments, a memory controller may be integrated into the processor 808. The processor 808 may be configured to execute computer-readable instructions stored in a memory (e.g., the memory 806) to cause the UE 800 to perform various functions.

The UE 800 may include a global positioning system (GPS) 810. The GPS 810 may be used for enabling location-based services or other services based on a geographical position of the UE 800 and/or synchronization among UEs. The GPS 810 may receive global navigation satellite systems (GNSS) signals from a single satellite or a plurality of satellite signals via the antenna 802 and provide a geographical position of the UE 800 (e.g., coordinates of the UE 800). In some embodiments, the UE 800 does not include the GPS 810.

The UE 800 may include an input/output (I/O) device 812 that may be used to communicate a result of signal processing and computation to a user or another device. The I/O device 812 may include a user interface including a display and an input device to transmit a user command to processor 808. The display may be configured to display a status of signal reception at the UE 800, the data stored at memory 806, a status of signal processing, and a result of computation, etc. The display may include, but is not limited to, a cathode ray tube (CRT), a liquid crystal display (LCD), a light-emitting diode (LED), a gas plasma display, a touch screen, or other image projection devices for displaying information to a user. The input device may be any type of computer hardware equipment used to receive data and control signals from a user. The input device may include, but is not limited to, a keyboard, a mouse, a scanner, a digital camera, a joystick, a trackball, cursor direction keys, a touchscreen monitor, or audio/video commanders, etc.

The UE 800 may further include a machine interface 814, such as an electrical bus that connects the transceiver 804, the memory 806, the processor 808, the GPS 810, and the I/O device 812.

In some embodiments, the UE 800 may be configured or programmed to perform a carrier aggregation in a sidelink communication. The processor 808 may be configured or programmed to execute the instructions stored in the memory 806 to transmit one or more packets on one or more carriers of a plurality of carriers that are to be used for a sidelink carrier aggregation; determine at least one of: reception of an ACK from each of one or more target receiver UEs, or non-reception of a NACK on at least one of the one or more carriers of the plurality of carriers; and cancel one or more remaining transmissions or re-transmissions for the one or more packets scheduled on the one or more carriers of the plurality of carriers, in response to a determination of at least one of: reception of the ACK from at least one of the one or more target receiver UEs, or non-reception of the NACK on the at least one of the one or more carriers of the plurality of carriers.

As used in this disclosure, use of the term “or” in a list of items indicates an inclusive list. The list of items may be prefaced by a phrase such as “at least one of” or “one or more of.” For example, a list of at least one of A, B, or C includes A or B or C or AB (i.e., A and B) or AC or BC or ABC (i.e., A and B and C). Also, as used in this disclosure, prefacing a list of conditions with the phrase “based on” shall not be construed as “based only on” the set of conditions and rather shall be construed as “based at least in part on” the set of conditions. For example, an outcome described as “based on condition A” may be based on both a condition A and a condition B without departing from the scope of this disclosure.

In this specification, the terms “comprise,” “include,” or “contain” may be used interchangeably and have the same meaning and are to be construed as inclusive and open-ended. The terms “comprise,” “include,” or “contain” may be used before a list of elements and indicate that at least all of the listed elements within the list exist but other elements that are not in the list may also be present. For example, if A comprises B and C, both {B, C} and {B, C, D} are within the scope of A.

The present disclosure, in connection with the accompanied drawings, describes example configurations that are not representative of all the examples that may be implemented or all configurations that are within the scope of this disclosure. The term “exemplary” should not be construed as “preferred” or “advantageous compared to other examples” but rather “an illustration, an instance or an example.” By reading this disclosure, including the description of the embodiments and the drawings, it will be appreciated by a person of ordinary skills in the art that the technology disclosed herein may be implemented using alternative embodiments. The person of ordinary skill in the art would appreciate that the embodiments, or certain features of the embodiments described herein, may be combined to arrive at yet other embodiments for practicing the technology described in the present disclosure. Thus, the disclosure is not limited to the examples and designs described herein but is to be accorded the broadest scope consistent with the principles and novel features disclosed herein.

The flowcharts and block diagrams in the figures illustrate examples of the architecture, functionality, and operation of possible implementations of systems, methods, and devices according to various embodiments. It should be noted that, in some alternative implementations, the functions noted in blocks may occur out of the order noted in the figures. For example, two blocks shown in succession may, in fact, be executed substantially concurrently, or the blocks may sometimes be executed in the reverse order, depending upon the functionality involved. Likewise, additional steps may be included in such methods, and certain steps may be omitted or combined, in methods consistent with various embodiments.

It is understood that the described embodiments are not mutually exclusive, and elements, components, materials, or steps described in connection with one example embodiment may be combined with, or eliminated from, other embodiments in suitable ways to accomplish desired design objectives.

Reference herein to “some embodiments” or “some exemplary embodiments” means that a particular feature, structure, or characteristic described in connection with the embodiment can be included in at least one embodiment. The appearance of the phrases “one embodiment” “some embodiments” or “another embodiment” in various places in the present disclosure do not all necessarily refer to the same embodiment, nor are separate or alternative embodiments necessarily mutually exclusive of other embodiments.

Additionally, the articles “a” and “an” as used in the present disclosure and the appended claims should generally be construed to mean “one or more” unless specified otherwise or clear from context to be directed to a singular form.

Unless explicitly stated otherwise, each numerical value and range should be interpreted as being approximate as if the word “about” or “approximately” preceded the value of the value or range.

Although the elements in the following method claims, if any, are recited in a particular sequence, unless the claim recitations otherwise imply a particular sequence for implementing some or all of those elements, those elements are not necessarily intended to be limited to being implemented in that particular sequence.

It is appreciated that certain features of the present disclosure, which are, for clarity, described in the context of separate embodiments, may also be provided in combination in a single embodiment. Conversely, various features of the specification, which are, for brevity, described in the context of a single embodiment, may also be provided separately or in any suitable subcombination or as suitable in any other described embodiment of the specification. Certain features described in the context of various embodiments are not essential features of those embodiments, unless noted as such.

It will be further understood that various modifications, alternatives, and variations in the details, materials, and arrangements of the parts which have been described and illustrated in order to explain the nature of described embodiments may be made by those skilled in the art without departing from the scope. Accordingly, the following claims embrace all such alternatives, modifications, and variations that fall within the terms of the claims.

Clause 1: A method for carrier aggregation in a sidelink communication, the method comprising:
transmitting, by a first user equipment (UE), one or more packets on one or more carriers of a plurality of carriers that are to be used for a sidelink carrier aggregation;
determining, by the first UE, at least one of: reception of an acknowledgment (ACK) from each of one or more target receiver UEs, or non-reception of a negative acknowledgement (NACK) on at least one of the one or more carriers of the plurality of carriers; and
canceling, by the first UE, one or more remaining transmissions or re-transmissions for the one or more packets scheduled on the one or more carriers of the plurality of carriers, in response to a determination of at least one of: reception of the ACK from at least one of the one or more target receiver UEs, or non-reception of the NACK on the at least one of the one or more carriers of the plurality of carriers.

Clause 2: The method of clause 1, wherein the ACK and the NACK are hybrid automatic repeat request (HARQ) feedback signals.

Clause 3: The method of clause 1, wherein the one or more packets is one or more transport blocks in media access control (MAC) layer.

Clause 4: The method of clause 1, wherein canceling the one or more remaining transmissions or re-transmissions for the one or more packets further comprises:
canceling, by the first UE, the one or more remaining transmissions or re-transmissions for the one or more packets on the one or more carriers of the plurality of carriers, in response to a determination of reception of the ACK from each of the one or more target receiver UEs on one or more specific carriers of the plurality of carriers, the one or more specific carriers being configured or pre-configured.

Clause 5: The method of clause 1, wherein canceling the one or more remaining transmissions or re-transmissions for the one or more packets further comprises:
canceling, by the first UE, the one or more remaining transmissions or re-transmissions for the one or more packets on the one or more carriers of the plurality of carriers, in response to a determination of non-reception of the NACK on one or more specific carriers of the plurality of carriers, the one or more specific carriers being configured or pre-configured.

Clause 6: The method of clause 1, wherein canceling the one or more remaining transmissions or re-transmissions for the one or more packets further comprises: canceling, by the first UE, the one or more remaining transmissions or re-transmissions for the one or more packets on the one or more carriers of the plurality of carriers, in response to:
(a) a determination of reception of the ACK from each of the one or more target receiver UEs on one or more specific carriers of the plurality of carriers, the one or more specific carriers being configured or pre-configured; or
(b) a determination of non-reception of the NACK on the one or more specific carriers of the plurality of carriers.
Clause 7: The method of clause 6, further comprising: selecting, by the first UE, the one or more specific carriers based on at least one of:
(a) a highest channel busy ratio (CBR) level associated with the one or more carriers of the plurality of carriers;
(b) a highest sidelink reference signal received power (RSRP) level associated with the one or more carriers of the plurality of carriers; or
(c) an anchor carrier that is a pre-selected or pre-configured.
Clause 8: The method of clause 1, wherein canceling the one or more remaining transmissions or re-transmissions for the one or more packets further comprises:
canceling, by the first UE, the one or more remaining transmissions or re-transmissions for the one or more packets on one or more first carriers of the plurality of carriers, in response to:
(a) a determination of reception of the ACK or non-reception of the NACK from the at least one of the one or more target receiver UEs on one or more second carriers that are different from the one or more first carriers of the plurality of carriers, the one or more second carriers being configured or pre-configured; or
(b) a determination of non-reception of the NACK on the one or more second carriers that are different from the one or more first carriers of the plurality of carriers.
Clause 9: The method of clause 1, wherein canceling the one or more remaining transmissions or re-transmissions for the one or more packets further comprises:
canceling, by the first UE, the one or more remaining transmissions or re-transmissions for the one or more packets on the one or more carriers of the plurality of carriers, in response to a determination of reception of the ACK from at least one specific target receiver UE among the one or more target receiver UEs, the at least one specific target receiver UE being configured or pre-configured.

Clause 10: The method of clause 1, wherein canceling the one or more remaining transmissions or re-transmissions for the one or more packets further comprises:
canceling, by the first UE, the one or more remaining transmissions or re-transmissions for the one or more packets on the one or more carriers of the plurality of carriers, in response to:
(a) a determination of reception of the ACK from a specific number of UEs from among the one or more target receiver UEs, the specific number being configured or pre-configured; or
(b) a determination of reception of a quantity of the NACK on at least one of the plurality of carriers, the quantity being configured or pre-configured.

Clause 11: The method of clause 1, wherein canceling the one or more remaining transmissions or re-transmissions for the one or more packets further comprises:
canceling, by the first UE, the one or more remaining transmissions or re-transmissions for the one or more packets on the one or more carriers of the plurality of carriers, in response to:
(a) a determination of reception of the ACK from each of the one or more target receiver UEs; or
(b) a determination of non-reception of the NACK on the one or more carriers of the plurality of carriers.
Clause 12: The method of clause 1, further comprising:
scheduling, by the first UE, transmission of one or more other packets to one or more other target receiver UEs, using resources associated with the canceled one or more remaining transmissions or re-transmissions for the one or more packets.

Clause 13: The method of clause 1, wherein canceling the one or more remaining transmissions or re-transmissions for the one or more packets further comprises:
making no reservation of resources for the one or more re-transmissions for the one or more packets on the one or more carriers of the plurality of carriers, in response to a determination of reception of the ACK or non-reception of the NACK from a first number of target receiver UEs among the one or more target receiver UEs, the first number being greater than a threshold number, and the threshold number being configured or pre-configured.

Clause 14: The method of clause 13, wherein the threshold number is a function of at least one of: a priority of each of the one or more carriers or a CBR associated with each of the one or more carriers.

Clause 15: The method of clause 1, further comprising: selecting, by the first UE, the one or more carriers of the plurality of carriers on which the one or more packets is to be transmitted.

Clause 16:
The method of clause 15, wherein the one or more carriers of the plurality of carriers on which the one or more packets is to be transmitted are selected based on at least one of:
(a) a priority of each of the one or more carriers;
(b) a traffic load for each of the one or more carriers; or
(c) a number of unsuccessful receptions in X slots on each of the one or more carriers, the X being configured or pre-configured, where the X is a natural number.
Clause 17: The method of clause 16, further comprising: adjusting, by the first UE, a number of the selected one or more carriers of the plurality of carriers on which the one or more packets is to be transmitted.

Clause 18: The method of clause 17, wherein the number of the selected one or more carriers of the plurality of carriers on which the one or more packets is to be transmitted is dynamically adjusted based on at least one of:
(a) whether a metric calculated from CBRs associated with candidate carriers of the plurality of carriers is greater than a first threshold, the first threshold being configured or pre-configured; or
(b) whether the number of unsuccessful receptions on the one or more carriers is greater than a second threshold, the second threshold being configured or pre-configured.
Clause 19: The method of clause 18, wherein the metric calculated from the CBRs associated with the candidate carriers comprises at least one of: a maximum of the CBRs of the candidate carriers, a minimum of the CBRs of the candidate carriers, an average of the CBRs of the candidate carriers, or a median value of the CBRs of the candidate carriers.
Clause 20: The method of clause 18, wherein the configured or the pre-configured second threshold is a function of a priority of each of the one or more carriers and the CBR associated with each of the one or more carriers.
Clause 21: The method of clause 18, further comprising: excluding, by the first UE, at least one carrier from the candidate carriers in response to a determination that the number of unsuccessful receptions in the X slots on each of the one or more carriers is greater than a threshold, the threshold being configured or pre-configured.

Clause 22: The method of clause 1, further comprising: dynamically switching, by the first UE, between a groupcast and a unicast based on a number of the one or more target receiver UEs with unsuccessful receptions on the one or more carriers of the plurality of carriers.

Clause 23: The method of clause 22, wherein the first UE performs the groupcast, and the method further comprises:
switching, from the groupcast to the unicast, in response to a determination that the number of the one or more target receiver UEs with unsuccessful receptions is smaller than a threshold; and
performing a link adaptation for each of one or more unicast links.

Clause 24: The method of clause 23, wherein performing the link adaptation for each of the one or more unicast links further comprises:
applying a different block error rate (BLER) target for each of the one or more unicast links.

Clause 25: The method of clause 24, further comprising:
canceling the one or more remaining transmissions or re-transmissions for the one or more packets, in response to a determination that a number of NACKs corresponds to a higher BLER than an initial BLER target of a carrier.

Clause 26: The method of clause 1, wherein the ACK or the NACK is received by the first UE over a physical sidelink feedback channel (PSFCH).

Clause 27: The method of clause 2, wherein the one or more carriers of the plurality of carriers are a first set of carriers for the one or more packets transmission in which HARQ feedback is enabled, and the method further comprises:
performing one or more blind re-transmissions of the one or more packets using a second set of carriers of the plurality of carriers, the second set of carriers being different from the first set of carriers; and
stopping the one or more blind re-transmissions in response to a determination of reception of the ACK on at least one of the first set of carriers.

Clause 28: The method of clause 27, wherein the one or more packets transmission with the first set of carriers and the one or more blind re-transmissions with the second set of carriers are performed over a physical sidelink shared channel (PSSCH).

Clause 29: The method of clause 2, wherein the one or more carriers of the plurality of carriers are licensed carriers for the one or more packets transmission in which HARQ feedback is enabled, and the method further comprises:
performing one or more blind re-transmissions of the one or more packets using one or more unlicensed carriers; and
stopping the one or more blind re-transmissions in response to a determination of reception of the ACK on at least one of the licensed carriers.

Clause 30: The method of clause 29, wherein the one or more packets transmission on the licensed carriers and the one or more blind re-transmissions on the one or more unlicensed carriers are performed over a PSSCH.

Clause 31: The method of clause 1, wherein canceling the one or more remaining transmissions or re-transmissions for the one or more packets further comprises:
transmitting one or more indications about cancellation of one or more resource reservations already indicated on the one or more carriers of the plurality of carriers, wherein the one or more indications are transmitted over at least one of: a physical sidelink control channel (PSCCH), physical sidelink shared channel (PSSCH), physical sidelink feedback channel (PSFCH), medium access control (MAC) control element (CE), or higher layer.

Clause 32: The method of clause 29, wherein determining the at least one of: reception of an ACK from each of one or more target receiver UEs, or non-reception of a NACK on at least one of the one or more carriers of the plurality of carriers further comprises:
determining, by the first UE, at least one of: the reception of an ACK from each of one or more target receiver UEs, or the non-reception of a NACK on at least one of the one or more carriers of the plurality of carriers before a sidelink timer expires.

Clause 33: A first user equipment (UE) for a sidelink communication, the first UE comprising:
a memory storing an instruction; and
a processor configured to execute the instruction stored in the memory to: transmit one or more packets on one or more carriers of a plurality of carriers that are to be used for a sidelink carrier aggregation;
determine at least one of: reception of an acknowledgment (ACK) from each of one or more target receiver UEs, or non-reception of a negative acknowledgement (NACK) on at least one of the one or more carriers of the plurality of carriers; and
cancel one or more remaining transmissions or re-transmissions for the one or more packets scheduled on the one or more carriers of the plurality of carriers, in response to a determination of at least one of: reception of the ACK from at least one of the one or more target receiver UEs, or non-reception of the NACK on the at least one of the one or more carriers of the plurality of carriers.

Clause 34: The first UE of clause 33, wherein the ACK and the NACK are hybrid automatic repeat request (HARQ) feedback signals.

Clause 35: The first UE of clause 33, wherein the one or more packets is one or more transport blocks in media access control (MAC) layer.

Clause 36: The first UE of clause 33, wherein, in canceling the one or more remaining transmissions or re-transmissions for the one or more packets, the processor is further configured to execute the instruction stored in the memory to:
cancel the one or more remaining transmissions or re-transmissions for the one or more packets on the one or more carriers of the plurality of carriers, in response to a determination of reception of the ACK from each of the one or more target receiver UEs on one or more specific carriers of the plurality of carriers, the one or more specific carriers being configured or pre-configured.

Clause 37: The first UE of clause 33, wherein, in canceling the one or more remaining transmissions or re-transmissions for the one or more packets, the processor is further configured to execute the instruction stored in the memory to:
cancel the one or more remaining transmissions or re-transmissions for the one or more packets on the one or more carriers of the plurality of carriers, in response to a determination of non-reception of the NACK on one or more specific carriers of the plurality of carriers, the one or more specific carriers being configured or pre-configured.

Clause 38: The first UE of clause 33, wherein, in canceling the one or more remaining transmissions or re-transmissions for the one or more packets, the processor is further configured to execute the instruction stored in the memory to:
cancel the one or more remaining transmissions or re-transmissions for the one or more packets on the one or more carriers of the plurality of carriers, in response to:
(a) a determination of reception of the ACK from each of the one or more target receiver UEs on one or more specific carriers of the plurality of carriers, the one or more specific carriers being configured or pre-configured; or
(b) a determination of non-reception of the NACK on one or the more specific carriers of the plurality of carriers.

Clause 39: The first UE of clause 38, wherein the processor is further configured to execute the instruction stored in the memory to:
select the one or more specific carriers based on at least one of:
(a) a highest channel busy ratio (CBR) level associated with the one or more carriers of the plurality of carriers;
(b) a highest sidelink reference signal received power (RSRP) level associated with the one or more carriers of the plurality of carriers; or
(c) an anchor carrier that is pre-selected or pre-configured.

Clause 40: The first UE of clause 33, wherein, in canceling the one or more remaining transmissions or re-transmissions for the one or more packets, the processor is further configured to execute the instruction stored in the memory to:
cancel the one or more remaining transmissions or re-transmissions for the one or more packets on one or more first carriers of the plurality of carriers, in response to:
(a) a determination of reception of the ACK or non-reception of the NACK from the at least one of the one or more target receiver UEs on one or more second carriers that are different from the one or more first carriers of the plurality of carriers, the one or more second carriers being configured or pre-configured; or
(b) a determination of non-reception of the NACK on the one or more second carriers that are different from the one or more first carriers of the plurality of carriers.

Clause 41: The first UE of clause 33, wherein, in canceling the one or more remaining transmissions or re-transmissions for the one or more packets, the processor is further configured to execute the instruction stored in the memory to:
cancel the one or more remaining transmissions or re-transmissions for the one or more packets on the one or more carriers of the plurality of carriers, in response to a determination of reception of the ACK from at least one specific target receiver UE among the one or more target receiver UEs, the at least one specific target receiver UE being configured or pre-configured.

Clause 42: The first UE of clause 33, wherein, in canceling the one or more remaining transmissions or re-transmissions for the one or more packets, the processor is further configured to execute the instruction stored in the memory to:
cancel the one or more remaining transmissions or re-transmissions for the one or more packets on the one or more carriers of the plurality of carriers, in response to:
(a) a determination of reception of the ACK from a specific number of UEs from among the one or more target receiver UEs, the specific number being configured or pre-configured; or
(b) a determination of reception of a quantity of the NACK on at least one of the plurality of carriers, the quantity being configured or pre-configured.

Clause 43: The first UE of clause 33, wherein, in canceling the one or more remaining transmissions or re-transmissions for the one or more packets, the processor is further
configured to execute the instruction stored in the memory to: cancel the one or more remaining transmissions or re-transmissions for the one or more packets on the one or more carriers of the plurality of carriers, in response to:
(a) a determination of reception of the ACK from each of the one or more target receiver UEs; or
(b) a determination of non-reception of the NACK on the one or more carriers of the plurality of carriers.
Clause 44: The first UE of clause 33, wherein the processor is further configured to execute the instruction stored in the memory to:
schedule transmission of one or more other packets to one or more other target receiver UEs, using resources associated with the canceled one or more remaining transmissions or re-transmissions for the one or more packets.

Clause 45: The first UE of clause 33, wherein, in canceling the one or more remaining transmissions or re-transmissions for the one or more packets, the processor is further configured to execute the instruction stored in the memory to:
make no reservation of resources for the one or more re-transmissions for the one or more packets on the one or more carriers of the plurality of carriers, in response to a determination of reception of the ACK or non-reception of the NACK from a first number of target receiver UEs among the one or more target receiver UEs, the first number being greater than a threshold number, and the threshold number being configured or pre-configured.

Clause 46: The first UE of clause 45, wherein the threshold number is a function of at least one of: a priority of each of the one or more carriers or a CBR associated with each of the one or more carriers.

Clause 47: The first UE of clause 33, wherein the processor is further configured to execute the instruction stored in the memory to:
select the one or more carriers of the plurality of carriers on which the one or more packets is to be transmitted.

Clause 48: The first UE of clause 47, wherein the one or more carriers of the plurality of carriers on which the one or more packets is to be transmitted are selected based on at least one of:
(a) a priority of each of the one or more carriers;
(b) a traffic load for each of the one or more carriers; or
(c) a number of unsuccessful receptions in X slots on each of the one or more carriers, the X being configured or pre-configured, where the X is a natural number.

Clause 49: The first UE of clause 48, wherein the processor is further configured to execute the instruction stored in the memory to:
adjust a number of the selected one or more carriers of the plurality of carriers on which the one or more packets is to be transmitted.

Clause 50: The first UE of clause 49, wherein the number of the selected one or more carriers of the plurality of carriers on which the one or more packets is to be transmitted is dynamically adjusted based on at least one of:
(a) whether a metric calculated from CBRs associated with candidate carriers of the plurality of carriers is greater than a first threshold, the first threshold being configured or pre-configured; or
(b) whether the number of unsuccessful receptions on the one or more carriers is greater than a second threshold, the second threshold being configured or pre-configured.

Clause 51: The first UE of clause 50, wherein the metric calculated from the CBRs associated with the candidate carriers comprises at least one of: a maximum of the CBRs of the candidate carriers, a minimum of the CBRs of the candidate carriers, an average of the CBRs of the candidate carriers, or a median value of the CBRs of the candidate carriers.

Clause 52: The first UE of clause 50, wherein the configured or the pre-configured second threshold is a function of a priority of each of the one or more carriers and the CBR associated with each of the one or more carriers.

Clause 53: The first UE of clause 50, wherein the processor is further configured to execute the instruction stored in the memory to:
exclude at least one carrier from the candidate carriers in response to a determination that the number of unsuccessful receptions in the X slots on each of the one or more carriers is greater than a threshold, the threshold being configured or pre-configured.

Clause 54: The first UE of clause 33, wherein the processor is further configured to execute the instruction stored in the memory to:
dynamically switch between a groupcast and a unicast based on a number of the one or more target receiver UEs with unsuccessful receptions on the one or more carriers of the plurality of carriers.

Clause 55: The first UE of clause 54, wherein the first UE performs the groupcast, and the processor is further configured to execute the instruction stored in the memory to:
switch, from the groupcast to the unicast, in response to a determination that the number of the one or more target receiver UEs with unsuccessful receptions is smaller than a threshold; and
perform a link adaptation for each of one or more unicast links.

Clause 56: The first UE of clause 55, wherein, in performing the link adaptation for each of the one or more unicast links, the processor is further configured to execute the instruction stored in the memory to:
apply a different block error rate (BLER) target for each of the one or more unicast links.

Clause 57: The first UE of clause 56, wherein the processor is further configured to execute the instruction stored in the memory to:
cancel the one or more remaining transmissions or re-transmissions for the one or more packets, in response to a determination that a number of NACKs corresponds to a higher BLER than an initial BLER target of a carrier.

Clause 58: The first UE of clause 33, wherein the ACK or the NACK is received by the first UE over a physical sidelink feedback channel (PSFCH).

Clause 59: The first UE of clause 34, wherein the one or more carriers of the plurality of carriers are a first set of carriers for the one or more packets transmission in which HARQ feedback is enabled, and the processor is further configured to execute the instruction stored in the memory to:
perform one or more blind re-transmissions of the one or more packets using a second set of carriers of the plurality of carriers, the second set of carriers being different from the first set of carriers; and
stop the one or more blind re-transmissions in response to a determination of reception of the ACK on at least one of the first set of carriers.

Clause 60: The first UE of clause 59, wherein the one or more packets transmission with the first set of carriers and the one or more blind re-transmissions with the second set of carriers are performed over a physical sidelink shared channel (PSSCH).

Clause 61: The first UE of clause 34, wherein the one or more carriers of the plurality of carriers are licensed carriers for the one or more packets transmission in which HARQ feedback is enabled, and the processor is further configured to execute the instruction stored in the memory to:
perform one or more blind re-transmissions of the one or more packets using one or more unlicensed carriers; and
stop the one or more blind re-transmissions in response to a determination of reception of the ACK on at least one of the licensed carriers.

Clause 62: The first UE of clause 61, wherein the one or more packets transmission on the licensed carriers and the one or more blind re-transmissions on the one or more unlicensed carriers are performed over a PSSCH.

Clause 63: The first UE of clause 33, wherein, in canceling the one or more remaining transmissions or re-transmissions for the one or more packets, the processor is further configured to execute the instruction stored in the memory to:
transmit one or more indications about cancellation of one or more resource reservations already indicated on the one or more carriers of the plurality of carriers, wherein the one or more indications are transmitted over at least one of: a physical sidelink control channel (PSCCH), physical sidelink shared channel (PSSCH), physical sidelink feedback channel (PSFCH), medium access control (MAC) control element (CE), or higher layer.

Clause 64: The first UE of clause 33, wherein, in determining the at least one of: the reception of an ACK from each of one or more target receiver UEs, or the non-reception of a NACK on at least one of the one or more carriers of the plurality of carriers, the processor is further configured to execute the instruction stored in the memory to:
determine the at least one of: the reception of an ACK from each of one or more target receiver UEs, or the non-reception of a NACK on at least one of the one or more carriers of the plurality of carriers before a sidelink timer expires.

Clause 65: A non-transitory computer-readable medium storing instructions that are executable by one or more processors of a first user equipment (UE) for a sidelink communication to perform a method, the method comprising:
transmitting, by the first UE, one or more packets on one or more carriers of a plurality of carriers that are to be used for a sidelink carrier aggregation;
determining, by the first UE, at least one of: reception of an acknowledgment (ACK) from each of one or more target receiver UEs, or non-reception of a negative acknowledgement (NACK) on at least one of the one or more carriers of the plurality of carriers; and
canceling, by the first UE, one or more remaining transmissions or re-transmissions for the one or more packets scheduled on the one or more carriers of the plurality of carriers, in response to a determination of at least one of: reception of the ACK from at least one of the one or more target receiver UEs, or non-reception of the NACK on the at least one of the one or more carriers of the plurality of carriers.

1. A method for carrier aggregation in a sidelink communication, the method comprising:
transmitting, by a first user equipment (UE), one or more packets on one or more carriers of a plurality of carriers that are to be used for a sidelink carrier aggregation;
determining, by the first UE, at least one of: reception of an acknowledgment (ACK) from each of one or more target receiver UEs, or non-reception of a negative acknowledgement (NACK) on at least one of the one or more carriers of the plurality of carriers; and
canceling, by the first UE, one or more remaining transmissions or re-transmissions for the one or more packets scheduled on the one or more carriers of the plurality of carriers, in response to a determination of at least one of:
reception of the ACK from at least one of the one or more target receiver UEs, or non-reception of the NACK on the at least one of the one or more carriers of the plurality of carriers.

2. The method of claim 1, wherein the ACK and the NACK are hybrid automatic repeat request (HARQ) feedback signals.

3. The method of claim 1, wherein the one or more packets is one or more transport blocks in media access control (MAC) layer.

4. The method of claim 1, wherein canceling the one or more remaining transmissions or re-transmissions for the one or more packets further comprises:
canceling, by the first UE, the one or more remaining transmissions or re-transmissions for the one or more packets on the one or more carriers of the plurality of carriers, in response to a determination of reception of the ACK from each of the one or more target receiver UEs on one or more specific carriers of the plurality of carriers, the one or more specific carriers being configured or pre-configured.

5. The method of claim 1, wherein canceling the one or more remaining transmissions or re-transmissions for the one or more packets further comprises:
canceling, by the first UE, the one or more remaining transmissions or re-transmissions for the one or more packets on the one or more carriers of the plurality of carriers, in response to a determination of non-reception of the NACK on one or more specific carriers of the plurality of carriers, the one or more specific carriers being configured or pre-configured.

6. The method of claim 1, wherein canceling the one or more remaining transmissions or re-transmissions for the one or more packets further comprises:
canceling, by the first UE, the one or more remaining transmissions or re-transmissions for the one or more packets on the one or more carriers of the plurality of carriers, in response to:
(a) a determination of reception of the ACK from each of the one or more target receiver UEs on one or more specific carriers of the plurality of carriers, the one or more specific carriers being configured or pre-configured; or
(b) a determination of non-reception of the NACK on the one or more specific carriers of the plurality of carriers.

7. The method of claim 1, wherein canceling the one or more remaining transmissions or re-transmissions for the one or more packets further comprises:
canceling, by the first UE, the one or more remaining transmissions or re-transmissions for the one or more packets on one or more first carriers of the plurality of carriers, in response to:
(a) a determination of reception of the ACK or non-reception of the NACK from the at least one of the one or more target receiver UEs on one or more second carriers that are different from the one or more first carriers of the plurality of carriers, the one or more second carriers being configured or pre-configured; or
(b) a determination of non-reception of the NACK on the one or more second carriers that are different from the one or more first carriers of the plurality of carriers.

8. The method of claim 1, wherein canceling the one or more remaining transmissions or re-transmissions for the one or more packets further comprises:
canceling, by the first UE, the one or more remaining transmissions or re-transmissions for the one or more packets on the one or more carriers of the plurality of carriers, in response to a determination of reception of the ACK from at least one specific target receiver UE among the one or more target receiver UEs, the at least one specific target receiver UE being configured or pre-configured.

9. The method of claim 1, wherein canceling the one or more remaining transmissions or re-transmissions for the one or more packets further comprises:
canceling, by the first UE, the one or more remaining transmissions or re-transmissions for the one or more packets on the one or more carriers of the plurality of carriers, in response to:
(a) a determination of reception of the ACK from a specific number of UEs from among the one or more target receiver UEs, the specific number being configured or pre-configured; or
(b) a determination of reception of a quantity of the NACK on at least one of the plurality of carriers, the quantity being configured or pre-configured.

10. The method of claim 1, wherein canceling the one or more remaining transmissions or re-transmissions for the one or more packets further comprises:
canceling, by the first UE, the one or more remaining transmissions or re-transmissions for the one or more packets on the one or more carriers of the plurality of carriers, in response to:
(a) a determination of reception of the ACK from each of the one or more target receiver UEs; or
(b) a determination of non-reception of the NACK on the one or more carriers of the plurality of carriers.

11. The method of claim 1, further comprising:
scheduling, by the first UE, transmission of one or more other packets to one or more other target receiver UEs, using resources associated with the canceled one or more remaining transmissions or re-transmissions for the one or more packets.

12. The method of claim 1, wherein canceling the one or more remaining transmissions or re-transmissions for the one or more packets further comprises:
making no reservation of resources for the one or more re-transmissions for the one or more packets on the one or more carriers of the plurality of carriers, in response to a determination of reception of the ACK or non-reception of the NACK from a first number of target receiver UEs among the one or more target receiver UEs, the first number being greater than a threshold number, and the threshold number being configured or pre-configured.

13. The method of claim 1, further comprising:
selecting, by the first UE, the one or more carriers of the plurality of carriers on which the one or more packets is to be transmitted.

14. The method of claim 1, further comprising:
dynamically switching, by the first UE, between a groupcast and a unicast based on a number of the one or more target receiver UEs with unsuccessful receptions on the one or more carriers of the plurality of carriers.

15. The method of claim 1, wherein the ACK or the NACK is received by the first UE over a physical sidelink feedback channel (PSFCH).

16. The method of claim 1, wherein canceling the one or more remaining transmissions or re-transmissions for the one or more packets further comprises:
transmitting one or more indications about cancellation of one or more resource reservations already indicated on the one or more carriers of the plurality of carriers, wherein the one or more indications are transmitted over at least one of: a physical sidelink control channel (PSCCH), physical sidelink shared channel (PSSCH), physical sidelink feedback channel (PSFCH), medium access control (MAC) control element (CE), or higher layer.

17. A first user equipment (UE) for a sidelink communication, the first UE comprising:
a memory storing an instruction; and
a processor configured to execute the instruction stored in the memory to:
transmit one or more packets on one or more carriers of a plurality of carriers that are to be used for a sidelink carrier aggregation;
determine at least one of: reception of an acknowledgment (ACK) from each of one or more target receiver UEs, or non-reception of a negative acknowledgement (NACK) on at least one of the one or more carriers of the plurality of carriers; and
cancel one or more remaining transmissions or re-transmissions for the one or more packets scheduled on the one or more carriers of the plurality of carriers, in response to a determination of at least one of: reception of the ACK from at least one of the one or more target receiver UEs, or non-reception of the NACK on the at least one of the one or more carriers of the plurality of carriers.

18. The first UE of claim 17, wherein the ACK and the NACK are hybrid automatic repeat request (HARQ) feedback signals.

19. The first UE of claim 17, wherein the one or more packets is one or more transport blocks in media access control (MAC) layer.

20. A non-transitory computer-readable medium storing instructions that are executable by one or more processors of a first user equipment (UE) for a sidelink communication to perform a method, the method comprising:
transmitting, by the first UE, one or more packets on one or more carriers of a plurality of carriers that are to be used for a sidelink carrier aggregation;
determining, by the first UE, at least one of: reception of an acknowledgment (ACK) from each of one or more target receiver UEs, or non-reception of a negative acknowledgement (NACK) on at least one of the one or more carriers of the plurality of carriers; and
canceling, by the first UE, one or more remaining transmissions or re-transmissions for the one or more packets scheduled on the one or more carriers of the plurality of carriers, in response to a determination of at least one of:
reception of the ACK from at least one of the one or more target receiver UEs, or non-reception of the NACK on the at least one of the one or more carriers of the plurality of carriers.
